(19) United States
(12) Patent Application Publication
(10) Pub. No.: US 2009/0218265 A1
(43) Pub. Date: Sep. 3, 2009

(54) Instant Reverse-Flush Aquarium and Fish-Pond Filter

(76) Inventor: Philippe Alfred Dor, West Australia (AU)

Correspondence Address: MCNEELY BODENDORF LLP, P.O. BOX 34175, WASHINGTON, DC, 20043, US

(21) Appl. No.: 12/279,841

(22) PCT Filed: Feb. 8, 2007
(86) PCT No.: PCT/AU2007/000126

§ 371 Date: Feb. 19, 2009

(30) Foreign Application Priority Data
Feb. 15, 2006 (AU) 2006900737

(51) Int. Cl. B01D 24/46; A01K 63/04; B01D 24/10

(52) U.S. Cl. 210/167.25; 210/167.21; 210/275

(57) ABSTRACT

This self contained, add-on, self cleaning, instant reverse flush aquarium and/or fish-pond filter system is designed to capture all aquarium and/or pond solid detritus and to deposit them in the spaces between a heavy marbles-like filter substrate in such a way that these detritus can then be often and regularly evacuated by reverse-flush action from the filter-body and the vessel containing this filter-body, very fast, very easily, without any in-tank manual intervention and with a minimal amount of water wastage. This instant reverse-flush aquarium and/or fish-pond filter system will be available in many various sizes, shapes or models that can be added at any time to any aquatic life containing vessel of any shape or size, with the purpose of easily evacuating pollution causing debris as often as possible, hereby minimising the need for biological and/or chemical filtration stages and also drastically reducing other stress causing maintenance.

### FIELD OF INVENTION

Relates to self cleaning aquarium and/or fish-pond filter systems.

### BACKGROUND OF THE INVENTION

Almost all other aquarium and/or pond filters on the market today are in fact mini sewage plants. They have to biologically decompose the debris they capture in their substrate, and when this process has reached saturation they all still have to be cleaned by removing the filter or it's substrate, with much effort, stress and time involved for their user and sometimes even requiring the temporary removal of the live-stock, rocks, gravel and plants from the aquarium or fish-pond.

A minority of these other filters have separate mechanical filter parts that can be removed without too much trouble for partial cleaning to slightly reduce the load on the bacteria of the biological filter. Other filters also have removable chemical components or parts to neutralize toxins that can not be removed by the biological filter or are produced by it, and all this shows how inefficient traditional aquarium and/or fish-pond filters are, despite almost a century of research and development.

Our previous Australian patent 747968 and U.S. Pat. No. 6,234,113 B1 had already tried to solve the problem of removing the debris captured in the filter by elevating the substrate and flushing the debris collected underneath it while the fish were waiting in a separate “rock-pool” compartment. This system worked reasonably well but was commercially not viable, and only a small numbers of aquariums were ever produced with this system, which had to be built into the tank during it's construction.

However the new reverse-flush filter system which is derived from this first idea, has been developed over a period of 8 years to be self-contained, cheap to manufacture, easy to add to any existing aquarium or fish-pond of any shape or size, and still with it's main purpose being able to easily and regularly evacuate the solid detritus from the filter substrate instead of leaving these detritus to decompose on or in the filter substrate to be digested by the bacteria living on this substrate which are making up the so called “biological filter”.

### STATEMENT OR SUMMARY OF THE INVENTION

This is a self contained instant reverse flush aquarium and/or fish-pond filter system of which the main purpose is to be able to evacuate from this filter the solid debris captured by the mechanical function of the filter in a way that is very fast, very easy, with very little water wastage, and all this to reduce as much and as often as possible the source of the tank-water pollution and therefore also the load on the biological and chemical functions of this filter.

For this the substrate used in the conical filter-body compartment must always be smooth spherical heavy marbles preferably of not less than 8 mm diameter and not more than 18 mm in diameter (depending on the model and size of the filter), so that the detritus carried into the filter by the water-flow resulting from an air-lift or water-pump (power-head) action and passing through this marbles-like substrate contained in the filter body are able to settle-out by gravity separation in the spaces between the spherical marbles-like filter substrate while the clean water returns back to the aquarium or other vessel containing the aquatic life.
This 8-18 mm heavy spherical marbles-like filter substrate would never been used before in aquarium or fish-pond filters because it's surface area would be recognized by so called “experts” as being very insufficient for the “biological filter”, but our own extensive and comprehensive experience has shown that this factor is practically irrelevant in the case of aquariums or fish-ponds usually relatively low live fish-stock densities and is the result of an ill-conceived practice promoted by the aquarium industry out of pure commercial self interest, to the detriment of the interests of all aquarium hobbyists and aquarists.

The confirmation of this is clearly proven by the commonly called Berlin method which is the latest and most used method for indoor reef-aquariums, despite the fact that it does not have any “add-on” filter associated to it, so contradicting and negating all previously advanced ideas by the aquarium Industry promoting maximum add-on filter substrate surface area. Besides that, our aim is to remove the solid debris causing the pollution which might require the large biological filter substrate surface, as we believe that it is much better to avoid the cause of a problem rather than just treat the negative effects resulting from the problem.

The filter body containing this spherical marbles-like filter substrate has to be of a special conical shape to allow the debris to settle-out in the spaces between the marbles-like substrate and accumulate at the bottom of this conical filter body so that they can be removed via a horizontal draining system directly connected to a vertical or horizontal extractor pipe (with or without valve) which may be temporarily connected to a flexible hose for siphoning and/or flushing operations.

To evacuate the accumulated solid debris, in some reverse flush filter models this flexible hose is pushed on to the above water-level end of the vertical extractor stand-pipe and the accumulated debris are flushed out using suction from the siphoning flexible hose aided by the inherent gravity pressure of the water left in the aquarium.

With other reverse flush models, one need only to open for a few seconds the valve of the horizontal extractor pipe connected to the drain system and the pump pressure in the filter will flush out the debris trapped near the drain, in the empty spaces between the marbles-like filter substrate.

For all reverse-flush filter models this procedure takes between 3 and 20 seconds and will use only about 1 to 3 liters of water per flush, depending on the size and model of the filter in use. Nothing has to be touched in the aquarium or fish-pond and the fish are not disturbed at all by the procedure which is also completely painless for the hobbyist.

This often and regular removal of the aquarium solid detritus is extremely beneficial to the purity of the tank or pond water and the health of the fish, it will drastically reduce the work-load on the biological filter and also reduce the production of Nitrates, Phosphates and other harmful noxious chemical or organic components. All this will greatly minimize other aquarium maintenance which is another source of stress for the fish live-stock and for the hobbyist

Presently only large aquaculture Bubble Bead filters are, by using small floating beads combined with an air-bubble burst technique, able to do something slightly similar to our filter system and are achieving the fast and easy evacuation of most solid detritus captured and accumulated inside their floating beads filter substrate.

But by using relatively large and heavy marbles, our instant reverse-flush filter system is able to do this in a very different, much simpler and more economic way and for a much bigger size range and variety of aquatic vessels, plus our “Canister” and “Hang-on” reverse-flush models are the first aquarium/pond filters in the world having the possibility of 4 filter stages: mechanical, biological, chemical, and instant extraction of the captured solid debris.

### BRIEF DESCRIPTION OF THE DRAWINGS

FIG. 1: is a side view of the system according to an embodiment of the invention called “Vertical Action” filter driven by an air-curtain air-lift.

FIG. 2: is a perspective view of the system in FIG. 1.

FIG. 3: is showing the adaptation of the instant reverse flush system in an embodiment of a new modified commonly called “Canister” filter.

FIG. 4: is showing the adaptation of the instant reverse flush system in an embodiment of a new modified commonly called “Hang-on” (external or internal) filter.

FIG. 5: is showing the adaptation of the instant reverse flush system in an embodiment of a so called “Genie-in-a-Bottle” filter for fish-bowls or small fish-tanks.

### DETAILED DESCRIPTION

### All Figures

| | |
|---|---|
| TW = tank wall | TB = tank bottom |
| AL = air-lift | AC = air-curtain |
| FB = filter body | FG = filter grill |
| MS = marbles substrate | MS&SD = marbles substrate and solid debris |
| W&D = water and debris | CW = clean water |
| ED = extractor drain | EP = extractor pipe |
| WP = water-pump | S = Sand |
| FH = flexible hose | V = valve |
| CD = current deflector | SCV = siphon cut-out valve |

The water-flow in the filter-body (FB) containing the marbles-like substrate (MS) is driven by an air-curtain (AC) creating an air-lift (AL) or by a water-pump (WP) also called power-head. With this flow the mixture of water and debris (W&D) enters the filter-body via a grill (FG) or pipe and once inside the solid debris are separated from the water by gravity, allowing the clean water (CW) to return to the tank and the solid debris to settle in the spaces between the marbles-like substrate (MS&SD) close to the extractor drain (ED).

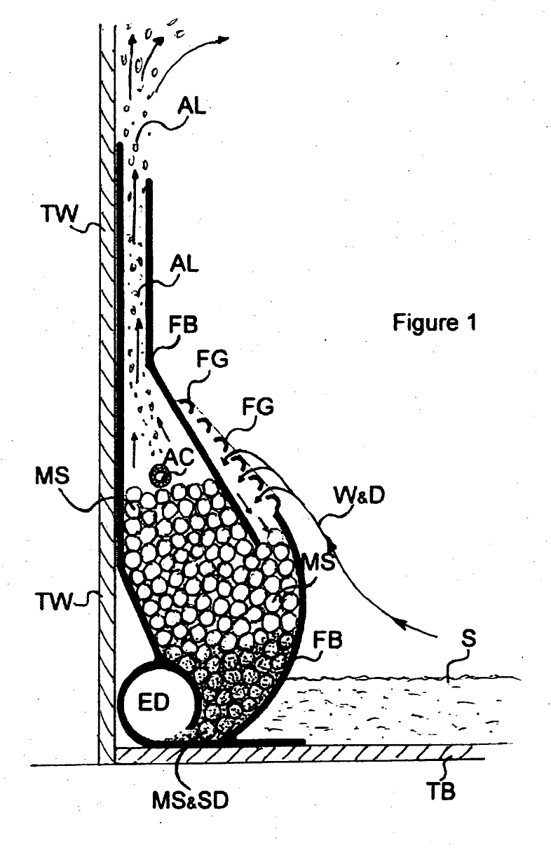

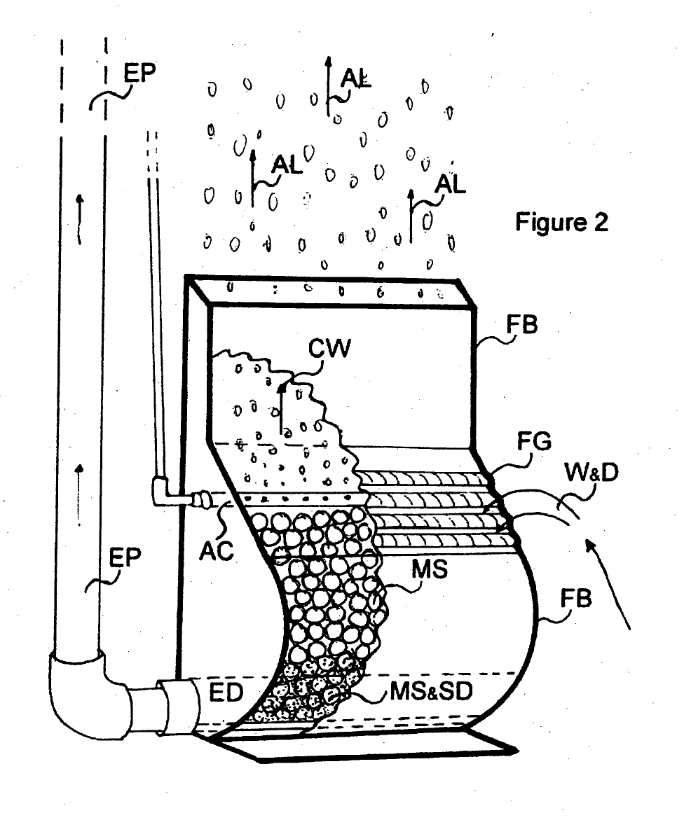

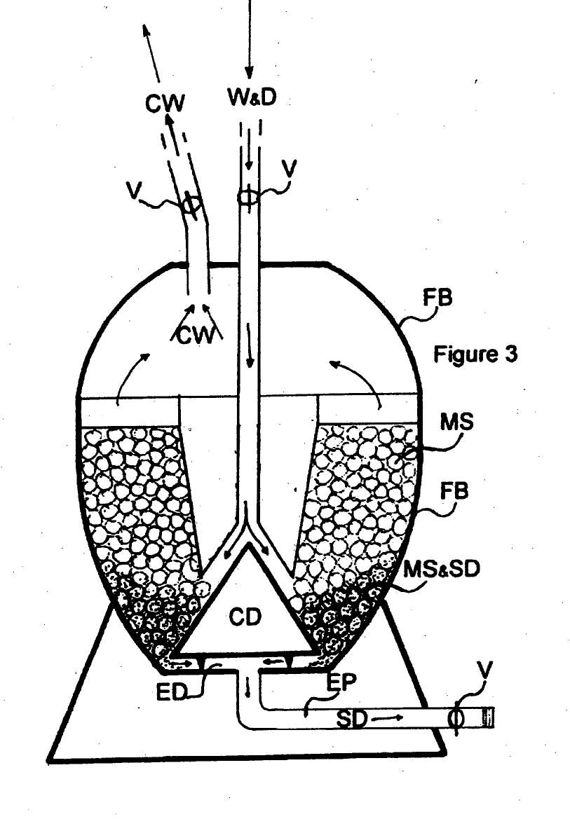

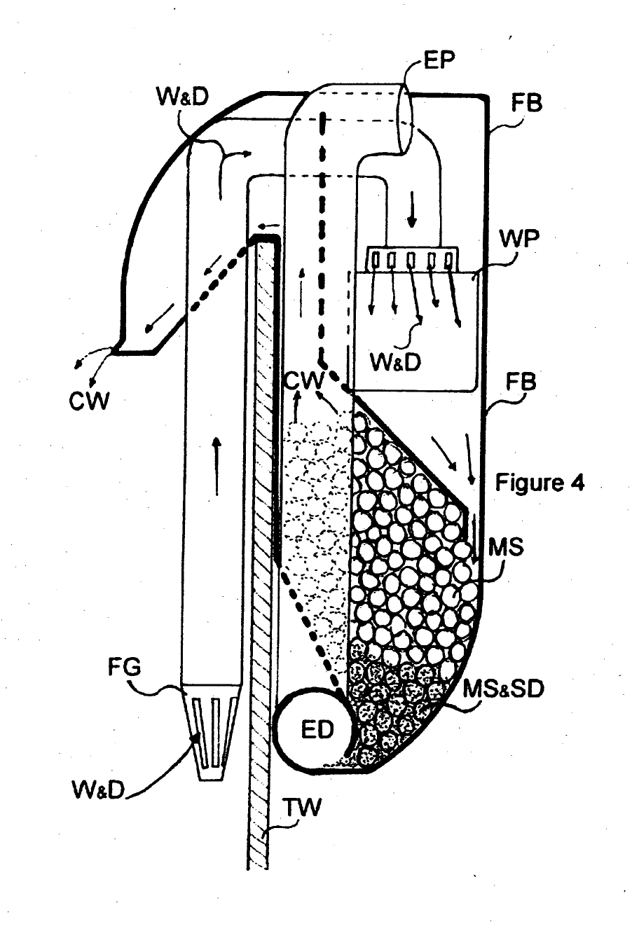

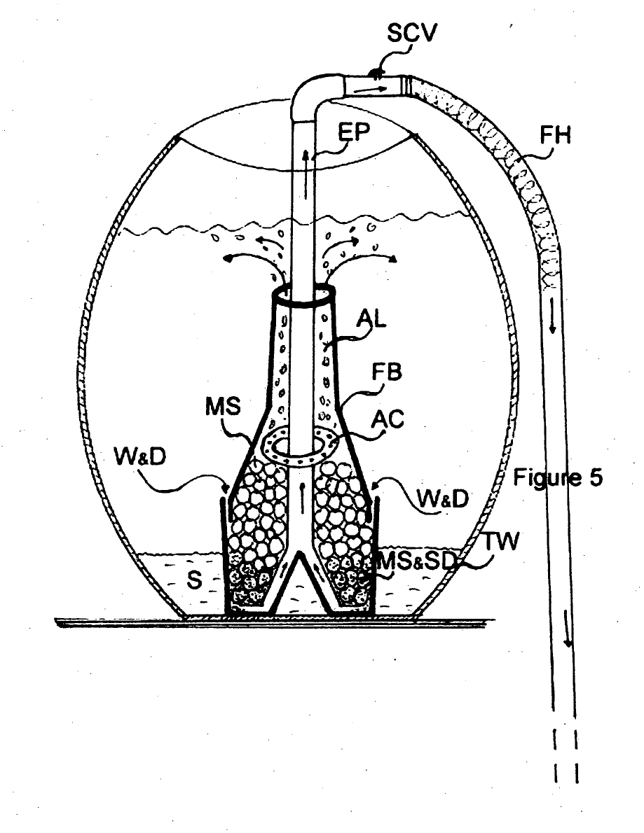

Depending on the model of filter, to remove the debris a flexible hose (FH) is connected temporarily to the vertical extractor pipe's end (EP in FIG. 1-2-4-5) which must always remain above the water-level of the tank having the filter, or a valve (V) on the horizontal extractor pipe (EP in FIG. 3) is turned open and siphon suction plus gravity or pump pressure is used to reverse the water-flow inside the filter-body and flush out the debris in a short burst of tank water, hereby eliminating the source of most of the pollution potentially affecting the aquarium or fish-pond fitted with this reverse-flush filter system. For greater efficiency, fine sand (S) is used on the bottom of the tanks instead of gravel, to avoid the debris getting trapped there in; this forces the debris to stay afloat and to end-up inside the filter-body, later to be removed by the reverse flushing of the filter-body.

1. A filter for use in external or sub merged applications in aquariums, fish-ponds or other aquatic vessels, the filter comprising a housing through which a fluid from the aquarium/pond/vessel flows, the housing comprising a compartment having a tapering portion which converges to provide a collection region which is in fluid communication with a drainage means, at least a lower portion of the tapering portion containing a substrate, wherein as the fluid passes through the substrate, debris is caused to be removed from the fluid flow and settle towards the collection region from which the debris can be discharged from the filter through the drainage means, the characteristic of the substrate causing debris to be caught therein at slow flow rates and to be released when high flow rates are used during reverse flow.

2. The filter according to claim 1 wherein the substrate is in the form of a plurality of substantially spherical or oval objects.

3. The filter according to claim 1 or 2 wherein each object has a diameter of 5 to 20 millimetres.

4. The filter according to claim 1, 2 or 3 wherein each object has a smooth outer surface

5. The filter according to any one of the preceding claims wherein the substrate is heavier than the fluid passing through the filter so as to remain at the bottom of the compartment when in use.

6. The filter according to any one of the preceding claims wherein the tapering portion has a frusto conical side profile.

7. The filter according to any one of claims 1 to 5 wherein the tapering portion is frusto conical.

8. The filter according to any one of claims 1 to 5 wherein the tapering portion has a conical side profile.

9. The filter according to any one of claims 1 to 5 wherein the tapering portion is conical.

10. The filter according to any one of claims 1 to 5 wherein the tapering portion is oval.

11. The filter according to any one of the preceding claims wherein the drainage means comprises an extractor pipe.

12. The filter according to claim 11 wherein the extractor pipe has a diameter between 20 and 100 millimetres.

13. The filter according to any one of the preceding claims wherein the fluid is returned to the aquarium/pond/vessel once it has passed through the substrate.

14. The filter according to any one of the preceding claims wherein the housing also comprises an inlet through which fluid from the aquarium/pond/vessel is caused to enter the filter.

15. The filter according to claim 14 wherein the inlet is in the form of a grill incorporated in the housing.

16. The filter according to claim 14 or 15 wherein the compartment has an Inlet which is in fluid communication with the inlet of the housing.

17. The filter according to claim 16 wherein the inlet of the compartment delivers the fluid from the filter at a position below the top level of the substrate.

18. The filter according to any one of the preceding claims wherein the compartment has an outlet which is in fluid communication with the aquarium/pond/vessel.

19. The filter according to any one of the preceding claims wherein the filter is driven by an air pump or water pump.

20. The filter according to any one of the preceding claims wherein the debris is selectively discharged from the filter.

21. This self contained, add-on, universally versatile instant reverse flush aquarium, fishpond, and/or other aquatic vessel filter system can be added internally or externally at any time to any water containing vessel of any shape or size with or without aquatic life and this filter system having or forming a conical or oval shaped lower body partly filled with a quantity of a negatively buoyant spherical filter substrate, all of similar and comparatively large size (over 5 nm in diameter) specifically calculated for the size of the filter body, where a mixture of water and solid debris is allowed to pass through by the action of an air-lift or water-pump and where the passing solid debris are able to separate out of this water-debris mixture and settle in the spaces between the same size balls of the spherical filter substrate near or at the bottom of the conical or oval filter body and close to an exacting drain system which is connected to a comparatively wide (over 20 mm OD) vertical or horizontal extractor pipe purposely designed and calculated to be able to evacuate in a few seconds, most of the solid debris captured in between the filter substrate by this filter system, through a powerful instant reverse flush of water and debris from and out of the filter body by siphon suction, gravity pressure, pump-pressure, or any combination of these 3 actions.

22. The system of claim 21 where this instant reverse-flush filter system is universally adaptable to any present or future, internal or external, air driven or power driven, variation of any aquatic vessel filter model of any shape or size and is the result of the following essential unalterable choice of three vital concept features:
A) A lower filter body partly filled with all similar size balls of a relatively large negatively buoyant spherical or near spherical filter substrate equally suited to capture aquatic debris as to evacuate these debris in-situ.
B) This lower filter body always forming a shape close to conical, oval or semi-spherical and permanently connected to an extracting drain system.
C) This horizontal or vertical drain system with or without valve being purposely designed to be able to evacuate instantly by reverse flush most of the water/debris contend from the concerned filter body in a few seconds only.
